(19) United States
(12) Patent Application Publication
(10) Pub. No.: US 2012/0102026 A1
(43) Pub. Date: Apr. 26, 2012

(54) SYSTEM AND METHOD FOR WORKERS COMPENSATION CLAIM MANAGEMENT

(75) Inventor: Julie FORTUNE, (US)

(73) Assignee: Arrowpoint Group, Inc.

(21) Appl. No.: 13/277,917

(22) Filed: Oct. 20, 2011

Related U.S. Application Data
(60) Provisional application No. 61/405,397, filed on Oct. 21, 2010.

(51) Int. Cl. G06F 17/30

(52) U.S. Cl. 707/722; 707/E17.014

(57) ABSTRACT

A system for providing a workers' compensation claim (WCC) management service include a data storage that stores a WCC database, wherein the WCC database comprises WCC data of a plurality of WCC transactions organized in digital form; and a user terminal configured to access the data storage to search and edit the WCC database and generate a dynamic report of the WCC transactions based on the WCC database.

### CROSS REFERENCE TO PRIOR APPLICATIONS

This application claims the benefit from U.S. Provisional Application No. 61/405,397 filed on Oct. 21, 2010, which is hereby incorporated herein by reference for all purposes as if fully set forth herein.

### FIELD OF THE DISCLOSURE

This disclosure is directed to workers' compensation claim management, and particularly to a system and method for managing workers' compensation claims.

### RELATED ART

Workers' compensation is a form of insurance that provides wage replacement and medical benefits for employees who are injured in the course of employment, in exchange for mandatory relinquishment of the employee's right to sue his or her employer for the tort of negligence. While plans differ between jurisdictions, provision can be made for weekly payments in place of wages (functioning in this case as a form of disability insurance), compensation for economic loss (past and future), reimbursement or payment of medical and like expenses (functioning in this case as a form of health insurance), and benefits payable to the dependents of workers killed during employment (functioning in this case as a form of life insurance). A number of computerized tools have been developed to assist management of a large volume of workers' compensation claims. However, none of the tools have demonstrated considerable success in providing a complete solution for WCC management. Accordingly, there is a need for a more efficient and effective system and method that provide a complete solution for managing a large volume of workers' compensation claims.

### SUMMARY OF THE DISCLOSURE

According to an aspect of the disclosure, a system for providing a workers' compensation claim (WCC) management service include a data storage that stores a WCC database, wherein the WCC database comprises WCC data of a plurality of WCC transactions organized in digital form, and a user terminal configured to access the data storage to search and edit the WCC database and generate a dynamic report of the WCC transactions based on the WCC database.

The system may further include a service provider that may include the data storage, and a client that may include the user terminal, wherein the service provider and the client may be connected to each other via one or more wired/wireless communication channels. Alternatively, the system may further include a client that may include the data storage and the user terminal.

The system may further include a remote communications device that may be configured to access the data storage via one or more wired/wireless communication channels to search and edit the WCC database.

The WCC data may be organized by a plurality of data fields of the WCC database. The plurality of data fields may include at least one of a payment type field, a paid group field, an year field, a status field, a claim type field, an account year field, a payment amount field, and a payment type description field.

The dynamic report may include at least one of a dynamic activity report, a dynamic cohort report, a dynamic settlement positional report, a dynamic frequency report, and a dynamic profile report.

The user terminal may include a WCC management tool for reviewing and editing the WCC data of the WCC database. The WCC management tool may display a plurality of windows on a screen. The plurality of windows may include at least one of a main window, a settlement team window, a plan of action window, a claimant window, a denied condition window, a settlement attempt window, a medical management window, a litigation window, and a lien window.

The WCC management tool may be configured to generate a dynamic report. The WCC management tool may be configured to generate at least one of a pharmacy benefit management report, an investigative report, a legal bill report, and the like.

According to another aspect of the disclosure, a process for providing workers' compensation claim (WCC) management service includes collecting raw WCC data; processing the raw WCC data using a computer to homogeneously consolidate the raw WCC data; reading the homogeneously consolidated data to a WCC database; providing the WCC database to a user terminal; and generating a dynamic report based on the WCC database using the user terminal.

The collecting the raw WCC data may include transmitting the raw WCC data from a client to a service provider via one or more wired/wireless communication channels, and the service provider may include a data storage for storing the WCC database. Alternatively, the WCC database is located at a data storage of a client.

The process may further include accessing the WCC data remotely from the WCC database via one or more wired/wireless communication channels to search and edit the WCC database.

The WCC data may be organized according to a plurality of data fields in the WCC database. The plurality of data fields may include at least one of a payment type field, a paid group field, an year field, a status field, a claim type field, an account year field, a payment amount field, and a payment type description field.

The dynamic report may include at least one of a dynamic activity report, a dynamic cohort report, a dynamic settlement positional report, a dynamic frequency report, and a dynamic profile report.

The process may further including reviewing and editing the WCC data of the WCC database using a WCC management tool installed in the user terminal. The WCC management tool may display a plurality of windows on a screen. The plurality of windows comprise at least one of a main window, a settlement team window, a plan of action window, a claimant window, a denied condition window, a settlement attempt window, a medical management window, a litigation window, and a lien window.

The WCC management tool may be configured to generate the dynamic report. The WCC management tool may be configured to generate at least one of a pharmacy benefit management report, and a legal bill report.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a system for providing workers' compensation claim (WCC) management services that is constructed according to the principles of the disclosure.

FIG. 2 shows a flowchart for a process for providing the WCC management services according to the principles of the disclosure.

FIG. 3A shows raw WCC data prior to performing homogeneous data consolidation.

FIG. 3B shows an example of a WCC database that is constructed according to the principles of the disclosure.

FIG. 3C shows an example of a dynamic report that is constructed according to the principles of the disclosure.

FIG. 4A shows an example of a dynamic activity report that is constructed according to the principles of the disclosure.

FIG. 4B shows an example of a dynamic cohort report that is constructed according to the principles of the disclosure.

FIG. 4C shows an example of a dynamic settlement positional report that is constructed according to the principles of the disclosure.

FIG. 4D shows an example of a dynamic frequency report that is constructed according to the principles of the disclosure.

FIG. 4E shows an example of a dynamic profile report that is constructed according to the principles of the disclosure.

FIG. 5A shows an example of a main window of a WCC management tool constructed according to the principles of the disclosure.

FIG. 5B shows an example of a settlement team window of the WCC management tool constructed an example of according to the principles of the disclosure.

FIG. 5C shows an example of a plan of action window of the WCC management tool constructed according to the principles of the disclosure.

FIG. 5D shows an example of a claimant window of the WCC management tool constructed according to the principles of the disclosure.

FIG. 5E shows an example of a denied condition window of the WCC management tool constructed according to the principles of the disclosure.

FIG. 5F shows an example of a settlement attempt window of the WCC management tool constructed according to the principles of the disclosure.

FIG. 5G shows an example of a medical management window of the WCC management tool.

FIG. 5H shows an example of a litigation window of the WCC management tool constructed according to the principles of the disclosure.

FIG. 5I shows an example of a lien window of the WCC management tool constructed according to the principles of the disclosure.

FIG. 6A shows an example of a pharmacy benefit management report that is constructed according to the principles of the disclosure.

FIG. 6B shows an example of a legal bill report that is constructed according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

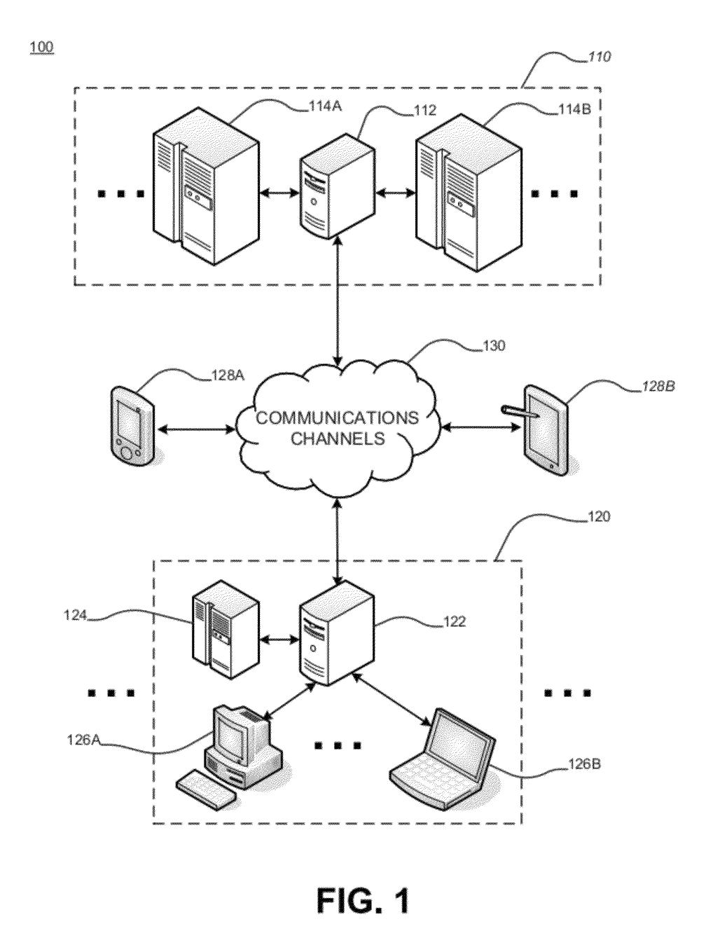

FIG. 1 shows a system 100 for providing workers' compensation claim (WCC) management services that is constructed according to the principles of the disclosure. The system 100 may include a service provider 110 and a plurality of clients that include a client 120. The service provider 110 may be connected to the client 120 via one or more wired/wireless communication channels 130 (e.g., local area network (LAN), personal area network (PAN), home area network (HAN), wide area network (WAN), campus network, metropolitan network, enterprise private network, virtual private network, internetwork, backbone network (BBN), global area network (GAN), the Internet, intranet, extranet, overlay network, cellular network, WiFi network, Bluetooth network, or the like, or a combination of two or more thereof). The service provider 110 may be administered by one or more operators. However, the service provider 110 may be configured to automatically carry out the WCC management services without any control or interference from the operators. The service provider 110 may include a server 112 and data storage 114, which may be connected to each other via one or more wired/wireless communication channels. The server 112 may include any type of programmable machine designed to sequentially and automatically carry out a sequence of arithmetic or logical operations, including, but not limited to, e.g., programmable device, mainframe, minicomputer, microcomputer, embedded computer, personal computer (PC), Quantum computer, Chemical computer, DNA computer, Optical computer, or the like. The server 112 may include a single programmable machine or a combination of two or more programmable machines. The server 112 may be located at the same place as the data storage 114 or may be located in a different place but connected to the data storage 114 via one or more wired/wireless communication channels.

The data storage 114 may store various WCC data collected from one or more sources, including data collected from the client 120. The WCC data may include, but is not limited to, e.g., claim data, settlement team data, plan of action data, claimant data, denied condition data, settlement attempts data, medical management data, litigation data, liens data, and the like. The collected WCC data may be organized in digital form to form a WCC database, which may be stored in the data storage 114. The server 112 may be configured to manage and operate the WCC database stored in the data storage 114. The data storage 114 may be any type of computer data storage device available on the market, including, but not limited to, e.g., hard disk drive, solid state drive, optical storage, magnetic tape, paper tape, punched card, or the like. The data storage 114 may be a single data storage device or a combination of two or more data storage devices (e.g., data storage 114A and 114B) that may be located in the same place or located in different places.

The client 120 may be, but is not limited to, e.g., an individual, a government entity, an organization, a company, an educational institution, a military entity, a labor union, a healthcare provider, a hospital, or any other institution that may benefit from effective and efficient WCC management. For example, the client 120 may be a state workers' compensation commission that is charged with administering a state's workers' compensation program. Alternatively, the client 120 may be a claim administrator or an organization that manages WCC activities on behalf of employers and workers' compensation insurance carriers. The client 120 may have a server 122, one or more data storages 124 and one or more user terminals 126, which are connected to each other via one or more wired/wireless communication channels. The server 122 may include any type of programmable machine designed to sequentially and automatically carry out a sequence of arithmetic or logical operations. The server 112 may include a single programmable machine or a combination of two or more programmable machines. The data storage 124 may include any type of computer data storage device available on the market. The user terminals 126 may also include any type of programmable machine designed to sequentially and automatically carry out a sequence of arithmetic or logical operations. For example, the user terminals 126 may include, but are not limited to, e.g., PC 126A, portable computer 126B, smartphone (e.g., Apple™ iPhone™, Google™ Android™ smartphone, RIM™ Blackberry™ smartphone, or the like), tablet computer (e.g., Apple™ iPad™, Samsung™ Galaxy Tab™, or the like), and the like. The system 100 may further include one or more remote communications devices 128 connected to the service provider 110 and/or the client 120 via the communication channels 130. The remote communications devices 128 may include, but are not limited to, e.g., smartphone 128A, tablet computer 128B, PC (not shown), desktop computer (not shown), portable computer (not shown), cellular phone (not shown), and the like. Each user terminal 126 and remote communications device 128 may include a user interface, such as, e.g., a screen, a keyboard/touch pad, a speaker/headphone, a microphone and/or the like (not shown).

The service provider 110 may carry out the WCC management services for the client 120. Alternatively, the client 120 may independently carry out the WCC management services using its own server 122 and data storage 124. In this case, the data storage 124 may store the WCC database and the server 122 may manage and operate the WCC database. The service provider 110 and the client 120 may jointly carry out the WCC management. For example, the client 120 may independently carry out the WCC management services, and the service provider 110 may keep a backup copy of the WCC database for emergency situations. To access the WCC management services, client software may be installed in each of the user terminals 126 and the remote communications devices 128 locally. Alternatively, the WCC management services may be web-based. For example, the server 112 may operate a web application to carry out the WCC management services, which may be accessed by the user terminals 126 via the communication channels 130. The web application may be hosted in a browser-controlled environment (e.g., a Java applet, or the like), coded in a browser-supported language (e.g., JavaScript combined with a browser-rendered markup language (e.g., Hyper Text Markup Language (HTML), or the like), or the like, such that any user terminal 126 or remote communications device 128 that runs a common web browser (e.g., Internet Explorer™, Firefox™, Chrome™, or the like) may render the application executable. The web-based service may be more beneficial due to the ubiquity of web browsers and the convenience of using a web browser as a client (i.e., thin client). Further, with inherent support for cross-platform compatibility, the web application may be maintained and updated without distributing and installing software on potentially a large number of the user terminals 126 and the remote communications devices 128. A mobile application may be installed in each of the remote communications devices 128 to allow the remote communications device 128 to access the service provider 110 and/or the client 124. Furthermore, the system 100 may include an ASP.net frontend and a SQL server for storing the WCC database.

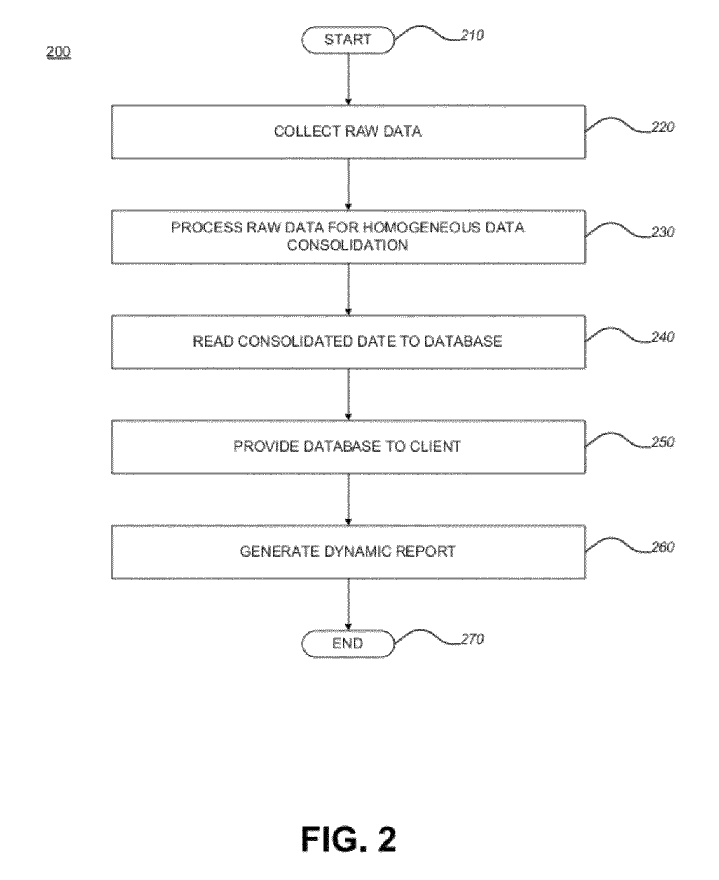

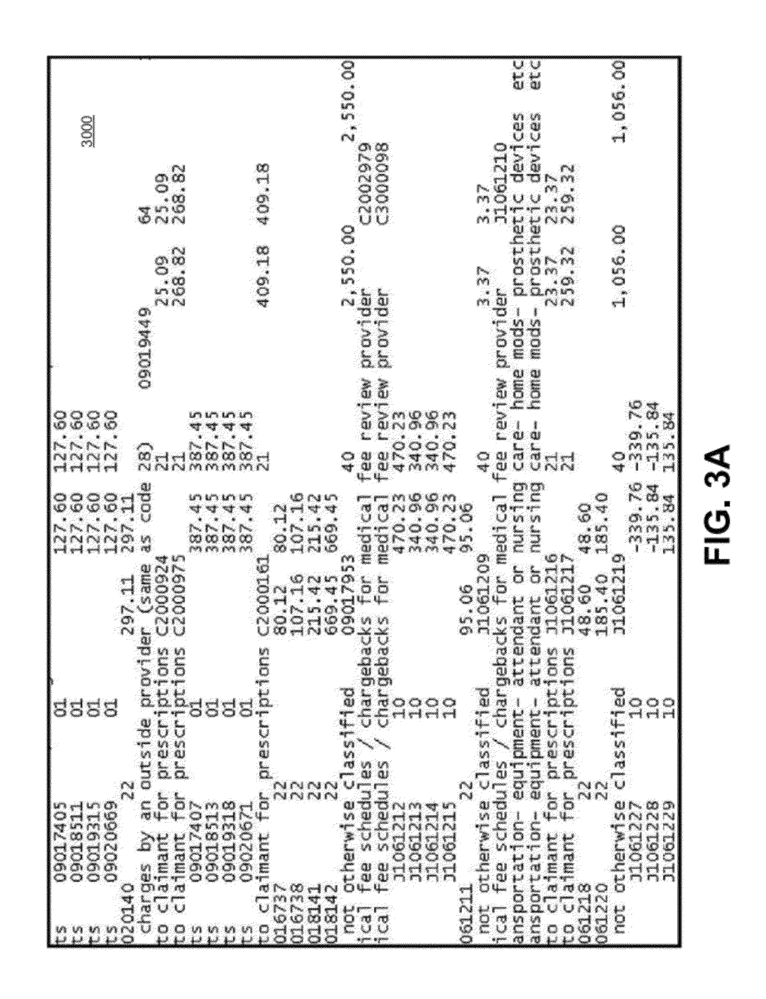

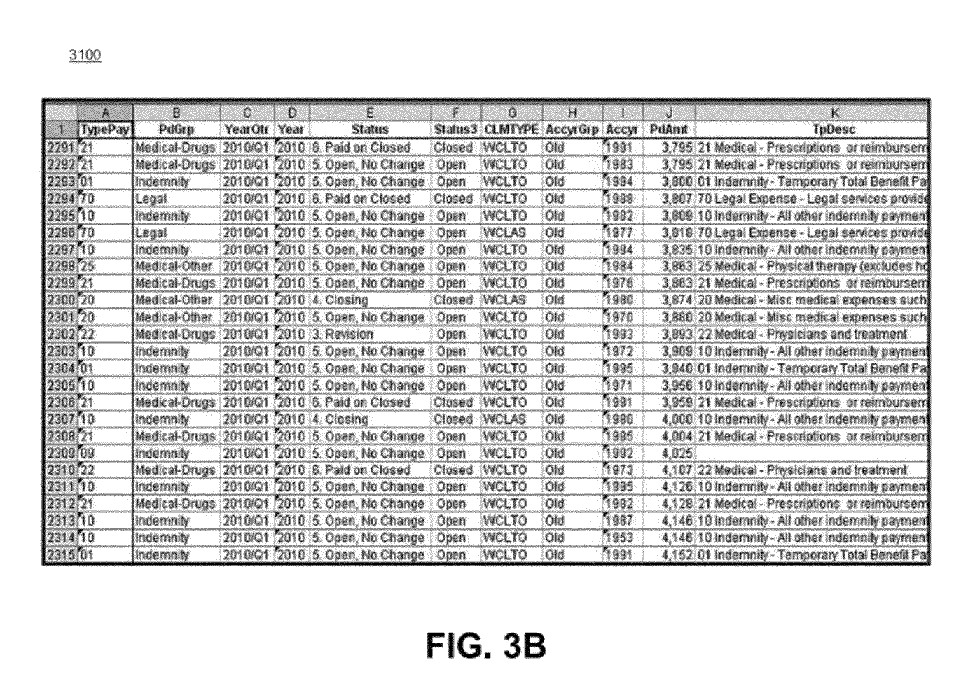

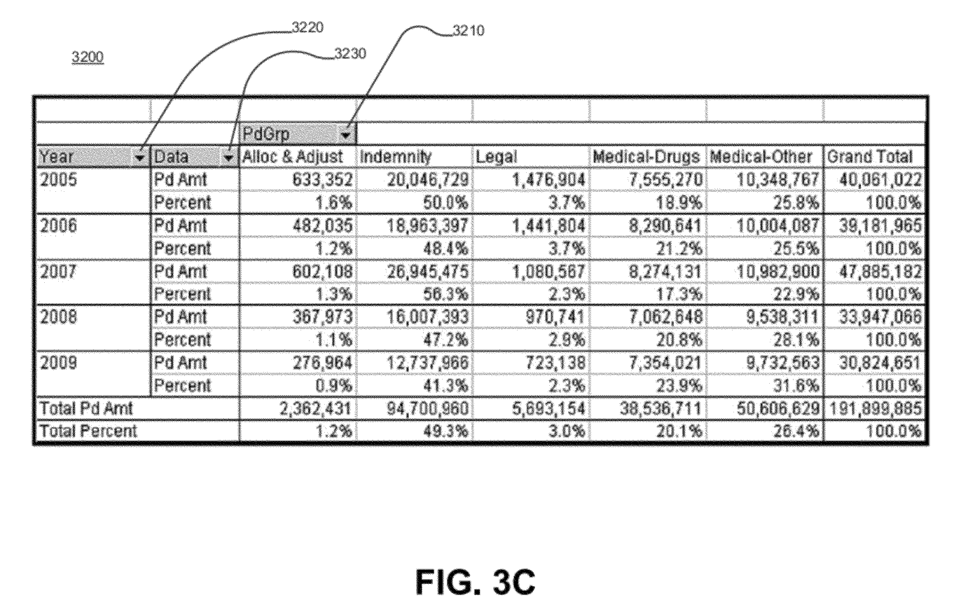

FIG. 2 shows a flowchart for a process 200 for providing the WCC management services using, e.g., the system 100 shown in FIG. 1, according to the principles of the disclosure. Upon starting the process (at 210), the service provider 110 may collect raw WCC data from the client 120 (at 220). The format of the raw WCC data may not matter. For example, FIG. 3A shows an example of raw WCC data 3000. The raw WCC data 3000 may not be coherently organized, which may make it difficult to analyze the entire WCC portfolio and obtain critical WCC management information. The collected raw WCC data 3000 may then be processed (at 230) by, e.g., the server 112, the server 122, or the like, for homogeneous data consolidation. For example, the server 112 may convert the raw WCC data 3000 to usable WCC management information. The server 112 may “bucket” the values of the WCC transaction data through an iterative process (e.g., defining accident year groups, and the like), which may lend themselves to homogeneous consolidation. Other client information may be collected by the service provider 110, including, but not limited to, e.g., number of employees by department, and the like.

Subsequently, the server 122 may read the homogeneously consolidated data into the data storage 114 (at 240) to create the WCC database. The WCC database may be created using any database management system (MBMS), including, but not limited to, e.g., dBase™, Microsoft™ Access™, or the like. For example, FIG. 3B shows an example of a WCC database 3100, which may be created using Microsoft™ Access™ based on the homogeneously consolidated data. Various pieces of data of each WCC transaction may be arranged in the WCC database 3100 according to predefined rules. For example, the WCC database 3100 may include a plurality of fields, such as, e.g., “TypePay” (payment type), “PdGrp” (paid group), “YearQtr” (quarter of year), “Year,” “Status,” “Status3,” “CLMTYPE” (claim type), “AccyrGrp” (account year group), “Accyr” (account year), “PdAmt” (payment amount), “TpDesc” (payment type description), and the like. A WCC transaction (i.e., claim) stored in the WCC database 3100 may have a plurality of data entries entered in the plurality of designated data fields. The data entries for the same WCC transaction may be arranged on the same row. For example, the WCC transaction arranged on row No. 2300 has “20” in the “TypePay” field, “Medical-Other” in the “PdGrp” field, “2010/Q1” in the “YearQtr” field, “2010” in the “Year” field, “4. Closing” in the “Status” field, “Closed” in the “Status3” field, “WCLAS” in the “CLMTYPE” field, “Old” in the “AccyrGrp” field, “1980” in the “Accyr” field, “3,874” in the “PdAmt” field, “20. Medical—Misc medical expense such” in the “TpDesc” field, and the like.

Upon completing the WCC database 3100 (at 240), the WCC database 3100 may be provided to the client 120 (at 250). In other words, the WCC database 3100 may become accessible from the client 120. For example, The user terminals 126 and the remote communications devices 128 may access the data storage 114 to search and retrieve information from the WCC database 3100. In the case that the WCC database 3100 is stored in the data storage 124 of the client 120, the user terminals 126 and the remote communications devices 128 may access the data storage 124. Then, an operator may operate any one of the user terminals 126 and remote communications devices 128 to generate a dynamic report (at 260). The WCC data organized in the WCC database 3100 may be fed to a local spreadsheet program, such as, e.g., Microsoft™ Excel™, or the like, which may be installed in the user terminals 126 and the remote communications devices 128.

FIG. 3C shows an example of a dynamic report 3200 that may be generated based on the data fed from the WCC database 3100 according to the principles of the disclosure. The dynamic report 3200 may be created using, e.g., Microsoft™ Excel™. Using the pivot table functionality, the entire WCC database 3100 may be summarized in any manner with few mouse or keyboard operations. More specifically, the dynamic report 3200 may include a plurality of data entries arranged in a matrix of cells. The plurality of data entries may be arranged by one or more categories, such as, e.g., “PdGrp” (paid group), “Year,” “Data,” and the like. The “PdGrp” category may have various values, such as, e.g., “Medical-Drugs,” “Indemnity,” “Legal,” “Medical-Other,” “Alloc & Adjust,” and the like. The “Year” category may also have various values, such as, e.g., “2005,” “2006,” “2007,” “2008,” “2009,” and the like. The “Data” category may have various values, such as, e.g., “Pd Amnt” (paid amount), “Percent” (percentage), and the like.

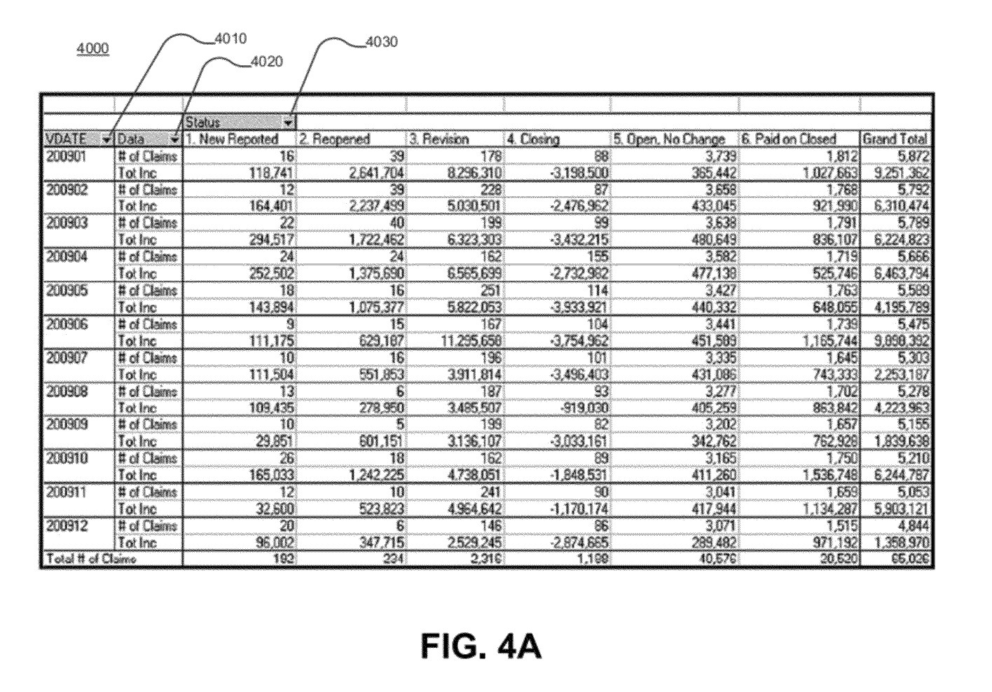

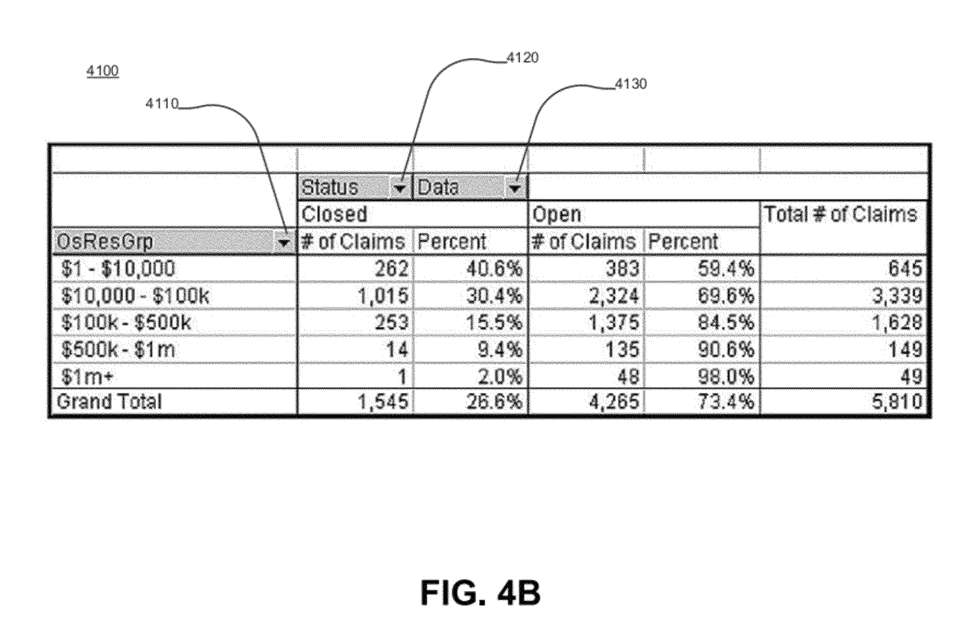

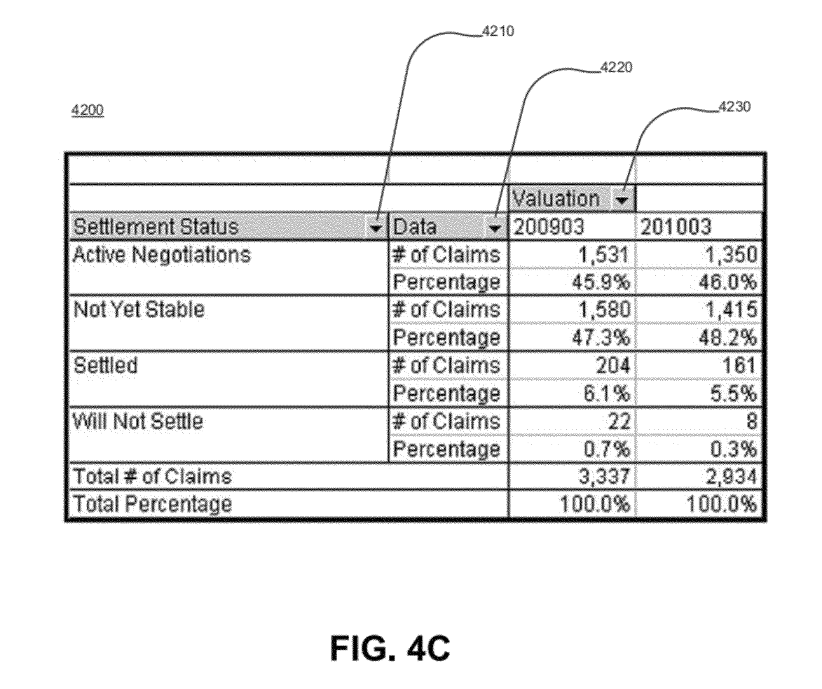

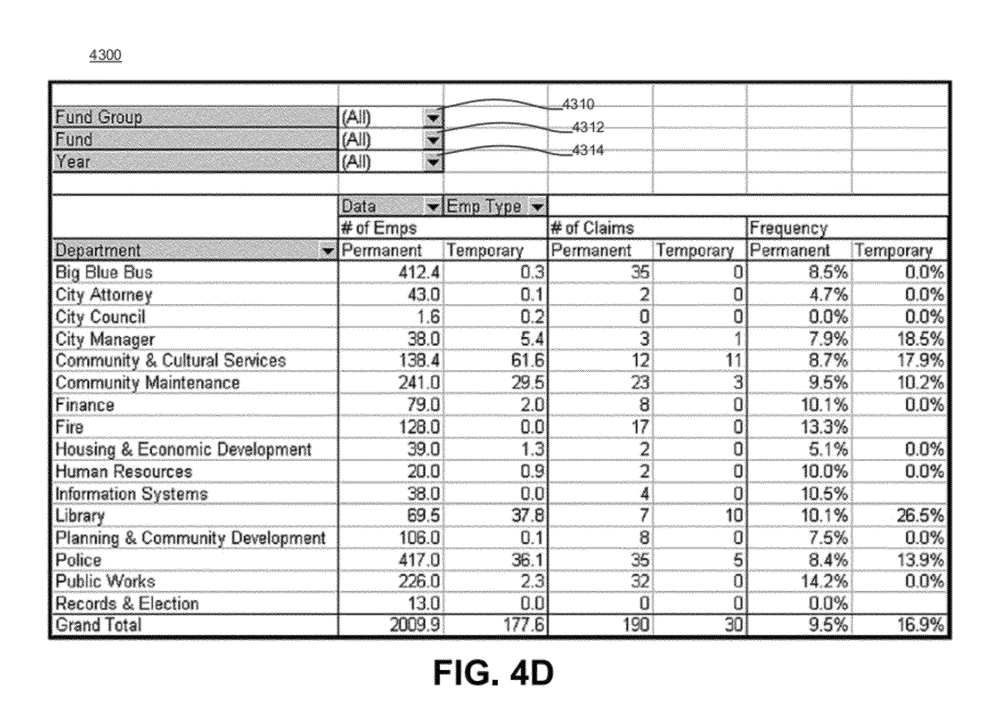

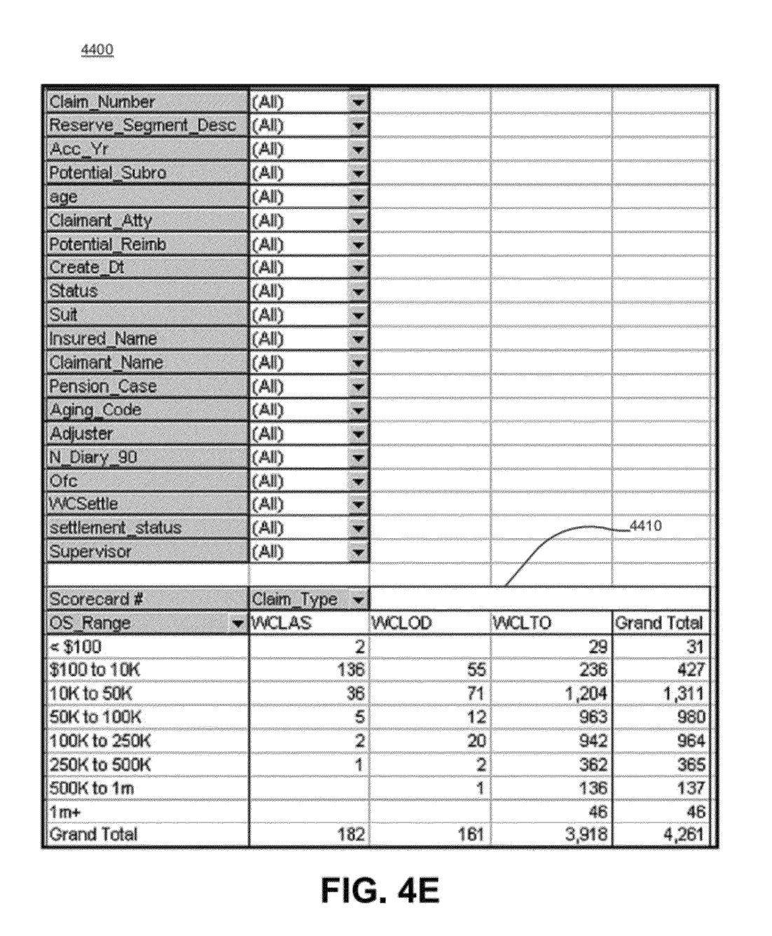

The dynamic report 3200 may further include a plurality of selection buttons, such as, e.g., “PdGrp” selection button 3210, “Year” selection button 3220, “Data” selection button 3230, and the like. The “PdGrp” selection button 3210 may be used to select one or more values of the “PdGrp” category. The “Year” selection button 3220 may be used to select one or more values of a “Year” category. The “Data” selection button 3230 may be used to select one or more values of the “Data” category. The dynamic report 3200 may also include a “Grand Total” column for displaying a total sum of the data entries in each value of the “Year” and “Data” categories. The dynamic report 3200 may further include a “Total Pd Amt” (total paid amount) row for displaying a total sum of the data entries in each value of the “PdGrp” category. Further, the WCC spreadsheet 3200 may include “Total Percentage” row for displaying a total sum of the data entries in each value of the “PdGrp” category. Using the dynamic report 3200, an operator may summarize financial and operational data in any fashion. The dynamic report 3200 may be generated in various ways to meet the client's demands, as shown in, e.g., FIGS. 4A, 4B, 4C, 4D and 4E. Thus, the WCC database 3100 may accommodate virtually limitless types of reporting requests on demand. After generating the dynamic report (at 260), the process 200 may terminate (at 270).

FIG. 4A shows a dynamic activity report 4000 for monitoring activities for the entire WCC database 3100. The report 4000 may include a plurality of data entries arranged in a matrix. The plurality of data entries may be arranged by one or more categories, such as, e.g., “VDATE,” “Data,” “Status,” and the like. The “VDATE” category may have various values, such as, e.g., “200901” (January 2009), “200902” (February 2009), . . . , “200912” (December 2009), and the like. The “Data” category may also have various values, such as, e.g., “# of Claims” (number of claims), “Total Inc,” and the like. The “Status” category may have various values, such as, e.g., “1. New Reported,” “2. Reopened,” “3. Revision,” “4. Closing,” “5. Open, No Change,” “6. Paid on Closed,” and the like “Pd Amnt” (paid amount), “Percent” (percentage), and the like.

The report 4000 may include a plurality of selection buttons, such as, e.g., “VDATE” selection button 4010, “Data” selection button 4020, “Status” selection button 4030, and the like. The “VDATE” selection button 4010 may be used to select one or more values of the “VDATE” category. The “Data” selection button 4020 may be used to select one or more values of the “Data” category. The “Status” selection button 4030 may be used to select one or more values of the “Status” category. The report 4000 may also include a “Grand Total” column for displaying a total sum of the data entries in each value of the “VDATE” and “DATA” categories. The report 4000 may further include a “Total # of Claims” row for displaying a total sum of the data entries that has the “# of Claims” value in the “Data” category for each value of the “Status” category. Using the report 4000, the operator may categorize the WCC transactions on a monthly basis by the current claim status (i.e., values in the “Status” row), monitor payment (i.e., values in the “Total Inc” rows of the “Data” column), and reserve activities accordingly.

FIG. 4B shows a dynamic cohort report 4100 for setting goals and monitoring closure percentages by size, complexity, adjuster, etc. A cohort may be a group of entities that (i) has a common staring point, (ii) is closed to new entrants, and (iii) is tracked over the time. A fixed cohort of claims may be defined at, e.g., the beginning of an annual reporting period. These claims may be tracked with particular focus on settlement potential. The report 4100 may include a plurality of data entries arranged in a matrix. The plurality of data entries may be arranged by a plurality of categories, such as, e.g., “OsResGrp,” “Status,” “Data,” and the like. The “OsResGrp” category may include various values, such as, e.g., “$1-$10,000,” “$10,000-$100K,” “$100K-$500K,” “$500k-$1m,” “$1m+,” and the like. The “Status” category may include various values, such as, e.g., “Closed,” “Open,” and the like. The “Data” category may include various values, such as, e.g., “# of Claims,” “Percent,” and the like.

The report 4100 may further include a plurality of selection buttons, such as, e.g., “OsResGrp” selection button 4110, “Status” selection button 4120, “Data” selection button 4130, and the like. The “OsResGrp” selection button 4110 may be used to select one or more values of the “OsResGrp” category. The “Status” selection button 4120 may be used to select one or more values of “Status” category. The “Data” selection button 4130 may be used to select one or more values in the “Data” category. The report 4100 may further include a “Total # of Claims” row for displaying a total sum of the data entries in the “# of Claims” value of the “Data” category for each value of the “OsResGrp” category. The report 4100 may also include a “Grand Total” row for displaying a total sum of the data entries in each values of the “Status” and “Data” categories (e.g., “Closed” and “# of Claims,” “Closed” and “Percent,” “Open” and “# of Claims,” and “Open” and “Percent”). In the dynamic “cohort” report 4100, the operator may click on a cell to display the underlying claims and associated financial data.

FIG. 4C shows a dynamic settlement potential report 4200 for assessing settlement potential. The report 4200 may include a plurality of data entries arranged in a matrix. The plurality of data entries may be arranged by various categories, such as, e.g., “Settlement Status,” “Data,” “Valuation,” and the like. The “Settlement Status” category may include various values, such as, e.g., “Active Negotiations,” “Not Yet Stable,” “Settled,” “Will Not Settle,” and the like. The “Data” category may include various values, such as, e.g., “# of Claims,” “Percentage,” and the like. The “Valuation” category may include various values, such as, e.g., “200903” (March 2009), “201003” (March 2010), and the like.

The report 4200 may further include a plurality of selection buttons, such as, e.g., “Settlement Status” selection button 4210, “Data” selection button 4220, “Valuation” selection button 4230, and the like. The “Settlement Status” selection button 4210 may be used to select one or more values of the “Settlement Status” category. The “Data” selection button 4220 may be used to select one or both values of the “Data” category. The “Valuation” selection button 4230 may be used to select one or more values of the “Valuation” category. The report 4200 may further include a “Total # of Claims” row for displaying a total sum of the data entries of the “# of Claims” values of the “Data” category in each value of the “Valuation” category. The report 4200 may further include a “Total Percentage” row for displaying a total sum of the data entries of the “Percentage” values of the “Data” category in each value of the “Valuation” category. Using the report 4200, the operator may identify WCC transactions that are not yet stable and create action plans to move the unstable WCC transactions into active negotiations and resolution. Also, the operator may quickly figure out how well the WCC portfolio is being managed over a period of time.

FIG. 4D shows a dynamic frequency report 4300 for analyzing claim frequencies from various perspectives, such as, e.g., variances within departments between fund groups, relative frequencies of permanent employees vs. temporary employees, claim frequency over time, and the like. For example, the report 4300 shows that seventy nine (79) permanent employees and two (2) temporary employees of the finance department have made eight (8) claims and no (0) claim, respectively, which amount to 10.1% and 0% of the entire claims (relative frequency) in the WCC database 3100. Similar to the reports 3200, 4000, 4100 and 4200 shown in FIGS. 3C, 4A, 4B and 4C, respectively, the report 4300 may have a plurality of data entries arranged in a matrix. The plurality of data entries may be arranged by a plurality of categories, such as e.g., “Department,” “Data,” “Emp Type,” and the like. Each category may have various values. For example, the “Department” category has various values, such as, e.g., “Big Blue Bus,” “City Attorney,” “City Council,” etc. The report 4300 may also include a plurality of selection buttons to select one or more values for each category. The report 4300 may further include a “Grand Total” row for displaying a total sum of the data entities of each values of the “Data” and “Emp Type” categories. The report 4300 may further include a plurality of selections buttons 4310, 4312 and 4314 for selecting values for other categories, such as, e.g., “Fund Group,” “Fund,” “Year,” and the like.

FIG. 4E shows a dynamic profile report 4400 for reviewing open WCC transactions. The report 440 may have a plurality of selection buttons for selecting one or more values for a plurality of categories, which may include, but not limited to, e.g., “Claim_Number,” “Reserve_Segment_Desc,” “Acc_Yr,” “Potential_Subro,” “age,” “Claimant_Atty,” “Potential_Reimb,” “Create_Dt,” “Status,” “Suite,” “Insured_Name,” “Claimant_Name,” “Pension_Case,” “Aging_Code,” “Adjuster,” “N_Diary_{—}90,” “Ofc,” “WCSettle,” “Settlement Status,” “Supervisor,” and the like. The report 4400 may further include a scorecard 4410. The scorecard 4410 may include a plurality of data entries arranged in a matrix. The plurality of data entries may be arranged by a plurality of categories, such as, e.g., “OS_Range,” “Claim Type”, and the like. The “OS_Range” category may include various values, such as, e.g., “<$100” (less than $100), “$100 to 10K,” “10K to 50K,” “50K to 100K,” “100K to 250K,” “250K to 500K,” “500K to 1m” and “1m+” (more than one million dollars). The “Claim Type” category may include various values, such as, e.g., “WCLAS,” “WCLOD,” and “WCLTO.” Similar to the reports 3200, 4000, 4100, 4200 and 4300 shown in FIGS. 3C, 4A, 4B, 4C and 4D, respectively, the report 4400 may include a plurality of selection buttons for selecting one or more values for each categories. A new sheet (not shown) containing all claims detail for a cell in the scorecard 4410 may be automatically created when the cell is double-clicked. The scorecard 4410 may be designed to measure progress of the WCC transactions against established goals and target.

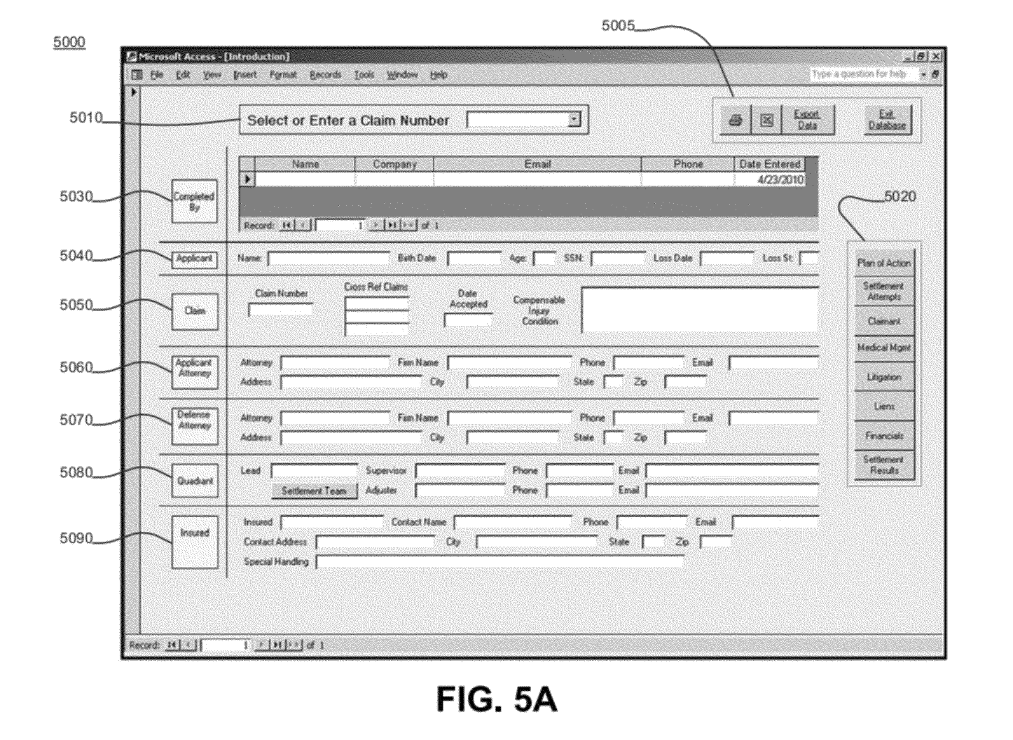

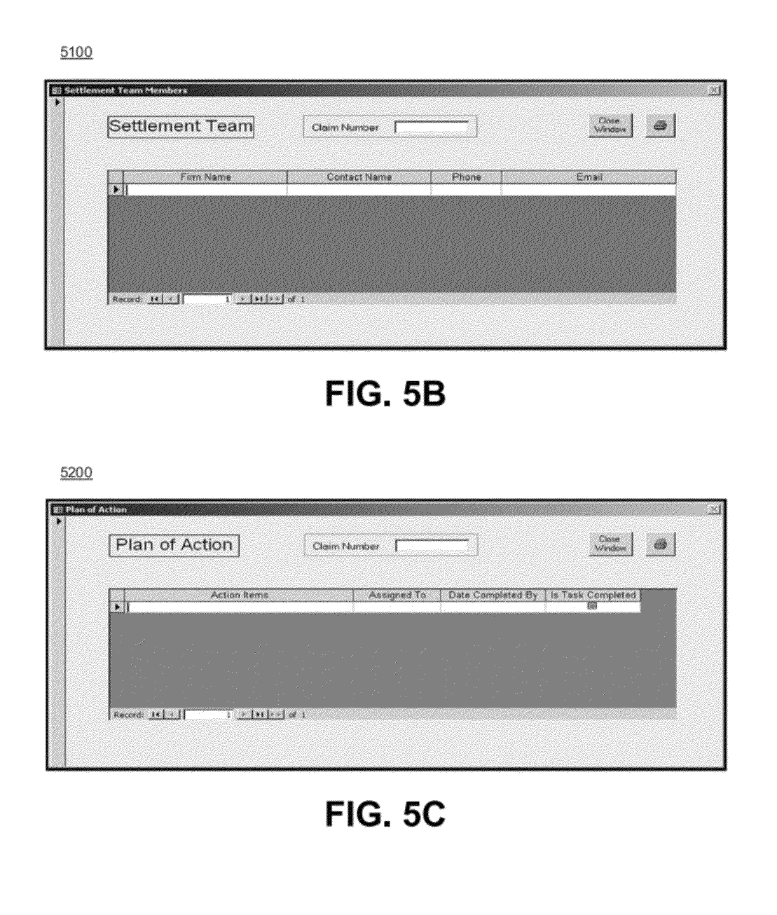

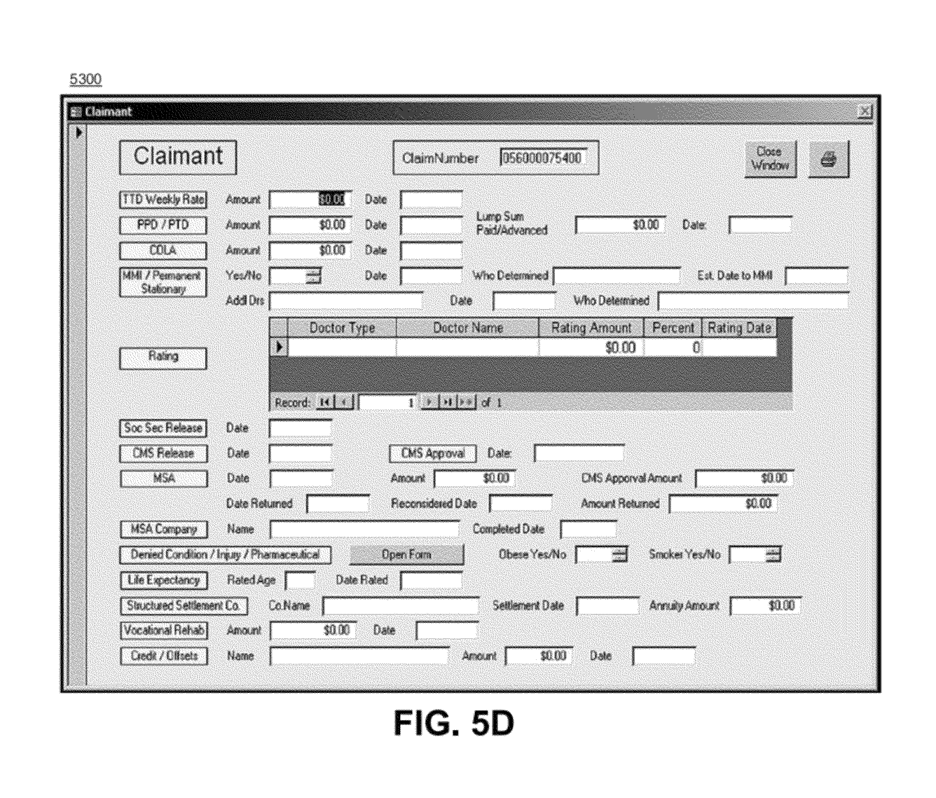

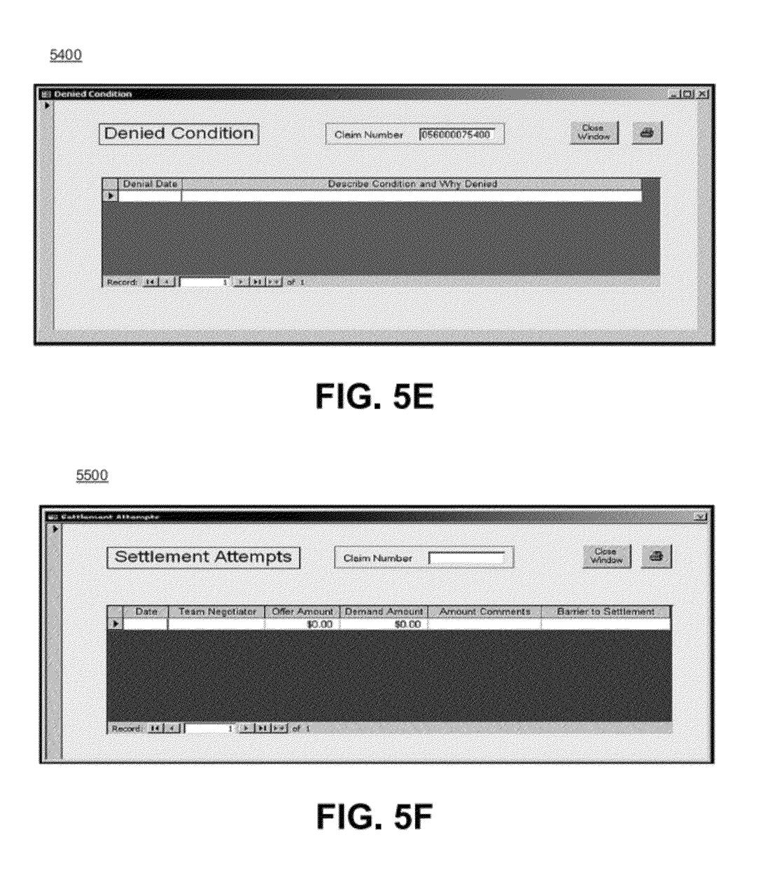

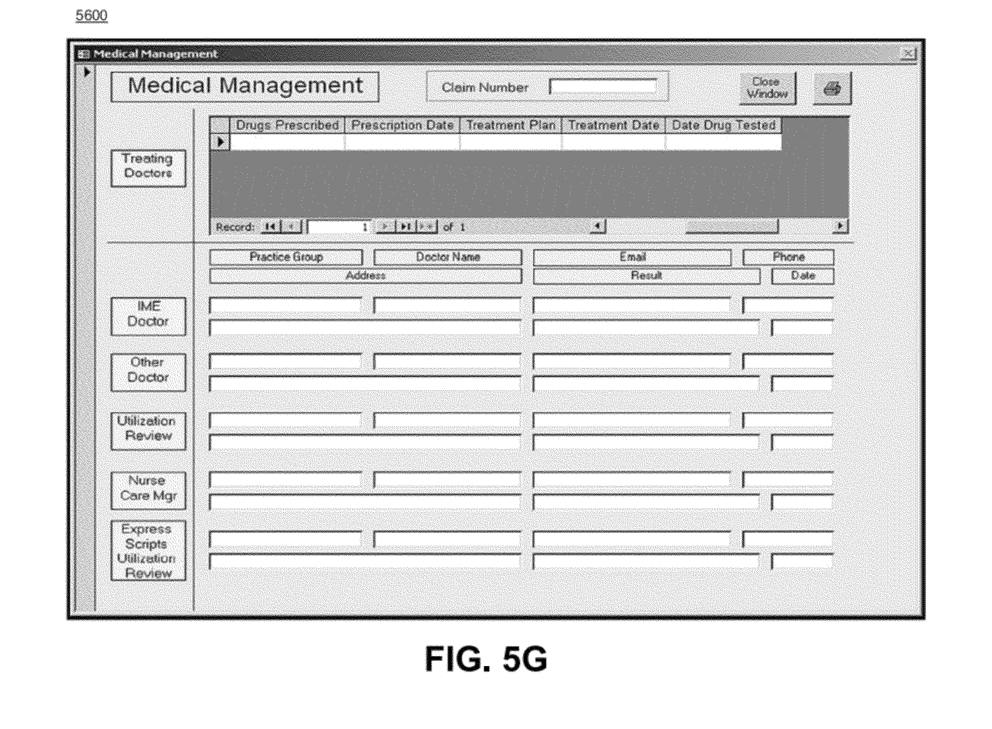

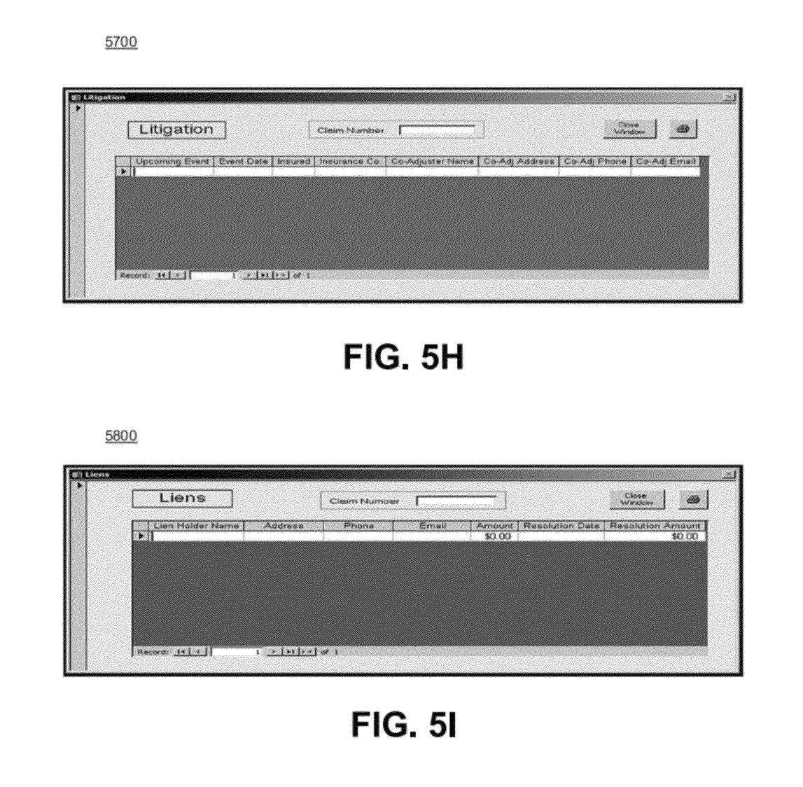

Referring to FIG. 1, the user terminals 126 and remote communication devices 128 may operate the software program for carrying out the WCC management services. In addition to creating the dynamic reports that are described above, the software program may allow the operator of the user terminal 126 and remote communication devices 128 to edit the WCC database 310 to create a new WCC transaction and edit the WCC data that is already in the WCC database 3100, and the like. The WCC management tool may be created using a relational database management system, such as, e.g., Microsoft™ Access™, or the like. The WCC management tool may have a plurality of windows for carrying out various functions of the WCC management services. For example, FIGS. 5A, 5B, 5C, 5D, 5E, 5F, 5G, 5H and 5I show various windows of the WCC management tool. Each window of the WCC management tool may have a plurality of data entry objects, such as, e.g., text box, drop-down list, checkbox, button, and the like for entering, editing and deleting data.

FIG. 5A shows a main window 5000 of the WCC management tool. The window 5000 may include a claim number section 5010 for issuing a claim number for a new WCC transaction or selecting an existing claim number of a WCC transaction that is already in the system 100 for review or editing. The window 5000 may further include a function bar 5005. The function bar 5005 may include a plurality of buttons, such as, e.g., “Print” button, “Excel™” button, “Export Data” button, “Exit Database” button, and the like. The “Excel™” button of the function bar 5005 may be used to create various dynamic reports described above. The window 5000 may further include a shortcut bar 5020, which may include a plurality of buttons for switching to different windows, such as, e.g., “Plan of Action” window 5200 (shown in FIG. 5C), “Settlement Attempts” window 5500 (shown in FIG. 5F), “Claimant” window 5300 (shown in FIG. 5D), “Medical Management” window 5600 (shown in FIG. 5J), “Litigation” window 5700 (shown in FIG. 5H), “Liens” window 5800 (shown in FIG. 5I), “Financials” window (not shown), “Settlement Result” (not shown), “Settlement Team” window 5100 (shown in FIG. 5B), “Denied Condition” window 5400 (shown in FIG. 5E), and the like. The window 5000 may further include a plurality of sections, such as, e.g., “Completed By” section 5030, “Applicant” section 5040, “Claim” section 5050, “Applicant Attorney” section 5060, “Defense Attorney” section 5070, “Quadrant” section 5080, “Insured” section 5090, and the like.

When a claim number of an existing WCC transaction is selected in the claim number section 5010, the information of the particular WCC transaction may be displayed in the sections 5040, 5050, 5060, 5070, 5080 and 5090. Then, the operator may review the information, add new information, and edit or delete the existing information. When a new claim number is selected in the claim number section 5010, all of the data entry objects may be empty or filled with predetermined values. The operator may enter new WCC transaction information in appropriate data entry objects. For example, the operator may enter his or her personal information, such as, e.g., name, company, email, phone, date entered, and the like, in the “Completed By” section 5030. When the operator's personal information is already stored in the WCC database 3100, the operator's information may be listed in the “Completed By” section 5030, which may be selected by the operator.

Once the operator selects his or her information in the “Completed By” section 5030, the operator may enter information related to the particular WCC transaction. For example, the operator may enter applicant information, such as, e.g., name, birth date, age, social security number (SSN), loss date, loss state, and the like, in the “Applicant” section 5040. The claim information, such as, e.g., claim number, cross-referenced claims, date accepted, compensable injury condition, and the like, may be entered in the “Claim” section 5050. The applicant attorney information, such as, e.g., attorney, firm name, phone, email, address, city, state, zip, and the like, may be entered in the “Applicant Attorney” section 5060. The defense attorney information, such as, e.g., attorney, firm name, phone, email, address, city, state, zip and the like, may be entered in the “Defense Attorney” section 5070. The quadrant information, such as, e.g., lead, supervisor, lead phone, lead email, settlement team, adjuster, adjuster phone, adjuster email, and the like, may be entered in the “Quadrant” section 5080. The insurance information, such as, e.g., insured person, contact name, phone, email, contact address, city, state, zip, special handling data, and the like, may be entered in the “Inured” section 5090.

FIG. 5B shows the settlement team window 5100, which may be used to review, enter, edit and delete settlement team information, such as, e.g., first name, contact name, phone, email, and the like. FIG. 5C shows a plan of action window 5200, which may be used to enter, edit or delete plan of action information, such as, e.g., action items, assigned to, date completed by, is task completed, and the like. FIG. 5D shows the claimant window 5300, which may be used to review, enter, edit and delete claimant information, such as, e.g., TTD weekly rate information (e.g., amount, date, and the like), PPD/PTD information (e.g., amount, date, and the like), lump sum paid/advanced information (e.g., amount, date, and the like), COLA information (e.g., amount, date, and the like), MMI/permanent stationary information (e.g., Yes/No, date, who determined, estimated date to MMI, and the like), rating information (e.g., doctor address, date, who determined, doctor type, doctor name, rating amount, percent, rating date, and the like), social security release information (e.g., date, and the like), CMS release information (e.g., date, and the like), CMS approval information (e.g., date, and the like), MSA information (e.g., date, amount, CMS approval amount, date returned, reconsidered date, amount returned, and the like), MSA company information (e.g., name, completed date, and the like), denied condition/injury/pharmaceutical information (e.g., “open form” button, obese Yes/No, smoker Yes/No, and the like), life expectancy information (e.g., rated age, date rated, and the like), structured settlement company information (e.g., company name, settlement date, annuity amount, and the like), vocational rehab information (e.g., amount, date, and the like), credit/offsets information (e.g., name, amount, date, and the like), and the like.

FIG. 5E shows the denied condition window 5400 of the WCC management tool, which may be used to review, enter, edit and delete denied condition information, such as, e.g., denial date, describe condition and why denied, and the like. FIG. 5F shows the settlement attempt window 5500 of the WCC management tool, which may be used to review, enter, edit and delete settlement attempts information, such as, date, team negotiator, offer amount, demand amount, amount comments, barrier to settlement, and the like. FIG. 5G shows the medical management window 5600 of the WCC management tool, which may used to review, enter, edit and delete medical management information, such as, e.g., treating doctors information (e.g., drug prescribed, prescription date, treatment plan, treatment date, date drug test, and the like), IME doctor information (e.g., practice group, doctor name, email, phone, address, result, date, and the like), other doctor information (e.g., practice group, doctor name, email, phone, address, result, date, and the like), utilization review information (e.g., practice group, doctor name, email, phone, address, result, date, and the like), nurse care manager information (e.g., practice group, doctor name, email, phone, address, result, date, and the like), express scripts utilization review (e.g., practice group, doctor name, email, phone, address, result, date, and the like), and the like. FIG. 5H shows the litigation window 5700 of the WCC management tool, which may be used to review, enter, edit and delete litigation information, such as, e.g., upcoming event, event date, insured, insurance company, co-adjuster name, co-adjuster address, co-adjuster phone, co-adjust email, and the like. FIG. 5I shows the lien window 5800 of the WCC management tool, which may be used to review, enter, edit and delete lien information, such as, e.g., lien holder name, address, phone, email, amount, resolution date, resolution amount, and the like.

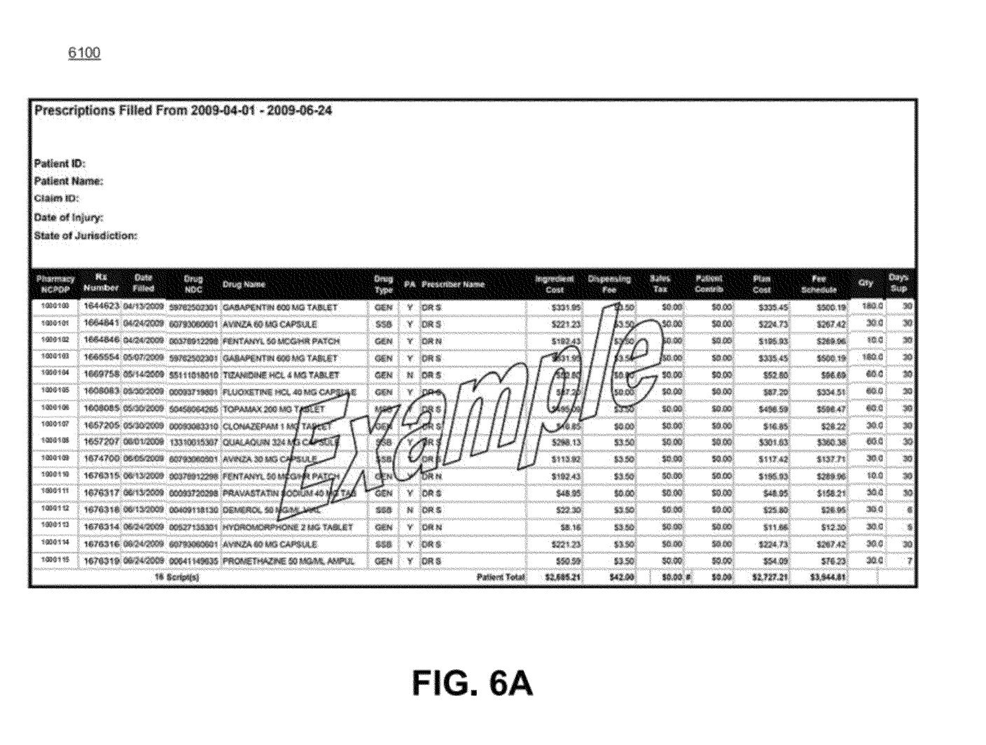

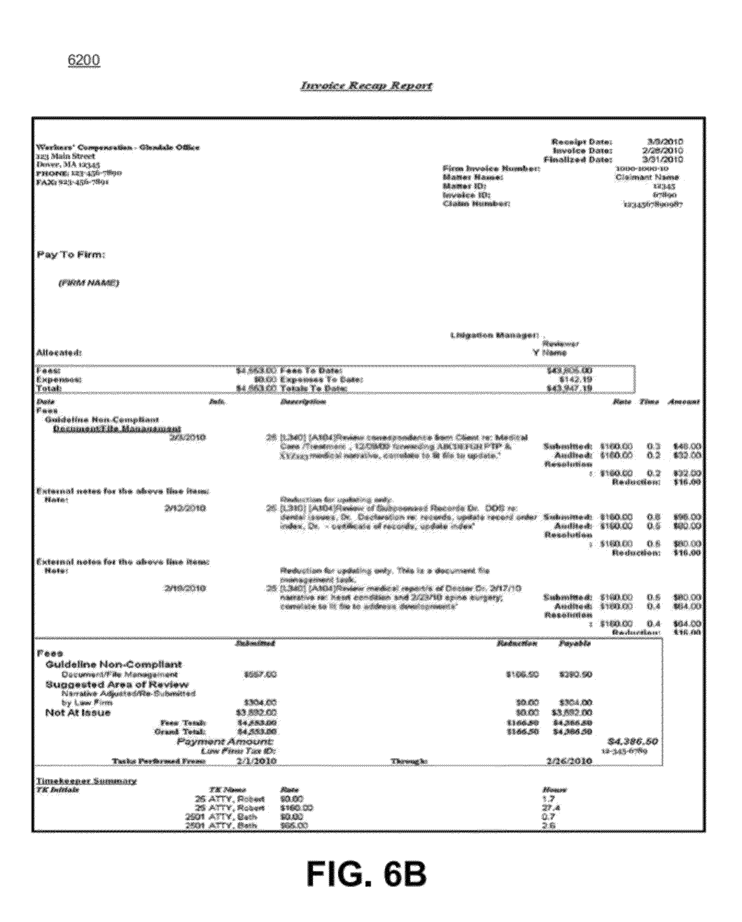

Additionally, the WCC management tool may be used to generate other reports, such as, e.g., pharmacy benefit management report 6100 (shown in FIG. 6A), legal bill report 6200 (shown in FIG. 6B), and the like. In FIG. 6A, the pharmacy benefit manger report 6100 may be used to review prescription drugs that are prescribed by a doctor or doctors and to provide medication therapy assessments and recommendations. The assessments and recommendations and any other investigative reports may be pulled in or imported to the report 6100 using, e.g., new or existing email, calendar, diary, task, and the like protocols (e.g., Microsoft™ Office™, IBM™ Lotus Symphony™, Corel™ WordPerfect Office™, Apple™ iWork™, and the like). The report 6100 may provide various pharmacy benefit management information, such as, e.g., description and classification of drugs, assessment of drugs, drugs' relations to injuries, dosage appropriateness, compliance with prescribed medication therapy, duration, whether a drug regime is a duplicate therapy, analysis of drug-to-drug interactions, generic drug information, additional therapeutic concerns/recommendations, and the like. When there are multiple issues and concerns, the report 6100 may be discussed with a treating physical in a peer-to-peer consultation and intervention. The consultation may be collegial with the focus on further understanding of the clinical situation and facilitating recommended drug therapy changes. Additionally, the report 6100 may include an estimated annual medication costs based on the existing therapy and recommendations, which may result in a substantial reduction in annual prescription drug costs for the client 120.

In FIG. 6B, the legal bill report 6200 may be generated for manual review by experts or automatic review by a dedicated review tool. The WCC management tool may allow a claim adjuster to participate in the legal bill review process prior to starting a claim adjustment process. The WCC management tool may also perform vendor review/recommendations based on analysis of transactions with current vendors.

The process 200 described in FIG. 2 and the processing steps described with references to FIG. 2 may be carried out by, for example, a mechanism (such as, for example, a machine, a robot, a person, or the like) operating under the control of, for example, a computer. For example, a computer program may be provided on a computer-readable medium, which may be executed on the server 112, server 122, user terminals 126, remote communications devices 128, or the like, to carry out each of the steps described with reference to FIG. 2 and to control the mechanism to carry out the WCC management services. The computer program may be provided on a computer readable medium.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G, 4G or 5G cellular standards, Bluetooth, or the like.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A system for providing a workers' compensation claim (WCC) management service, comprising:
a data storage that stores a WCC database, wherein the WCC database comprises WCC data of a plurality of WCC transactions organized in digital form; and
a user terminal configured to access the data storage to search and edit the WCC database and generate a dynamic report of the WCC transactions based on the WCC database.

2. The system of claim 1, further comprising:
a service provider that comprises the data storage; and
a client that comprises the user terminal,
wherein the service provider and the client are connected to each other via one or more wired/wireless communication channels.

3. The system of claim 1, further comprising a client that comprises the data storage and the user terminal.

4. The system of claim 1, further comprising a remote communications device that is configured to access the data storage via one or more wired/wireless communication channels to search and edit the WCC database.

5. The system of claim 1, wherein the WCC data is organized by a plurality of data fields of the WCC database, the plurality of data fields comprising at least one of:
a payment type field;
a paid group field;
an year field;
a status field;
a claim type field;
an account year field;
a payment amount field; and
a payment type description field.

6. The system of claim 1, wherein the dynamic report comprises at least one of:
a dynamic activity report;
a dynamic cohort report;
a dynamic settlement positional report;
a dynamic frequency report; and
a dynamic profile report.

7. The system of claim 1, wherein the user terminal comprises a WCC management tool for reviewing and editing the WCC data of the WCC database.

8. The system of claim 7, wherein the WCC management tool displays a plurality of windows on a screen, the plurality of windows comprise at least one of:
a main window;
a settlement team window;
a plan of action window;
a claimant window;
a denied condition window;
a settlement attempt window;
a medical management window;
a litigation window; and
a lien window.

9. The system of claim 7, wherein the WCC management tool is configured to generate the dynamic report.

10. The system of claim 7, wherein the WCC management tool is configured to generate at least one of:
a pharmacy benefit management report;
an investigative report; and
a legal bill report.

11. A process for providing workers' compensation claim (WCC) management service, comprising:
collecting raw WCC data;
processing the raw WCC data using a computer to homogeneously consolidate the raw WCC data;
reading the homogeneously consolidated data to a WCC database;
providing the WCC database to a user terminal; and
generating a dynamic report based on the WCC database using the user terminal.

12. The process of claim 11, wherein the collecting the raw WCC data comprises transmitting the raw WCC data from a client to a service provider via one or more wired/wireless communication channels, and
the service provider comprises a data storage for storing the WCC database.

13. The process of claim 11, wherein the WCC database is located at a data storage of a client.

14. The process of claim 11, further comprising accessing the WCC data remotely from the WCC database via one or more wired/wireless communication channels to search and edit the WCC database.

15. The process of claim 11, wherein the WCC data is organized according to a plurality of data fields in the WCC database, the plurality of data fields comprising at least one of:
a payment type field;
a paid group field;
an year field;
a status field;
a claim type field;
an account year field;
a payment amount field; and
a payment type description field.

16. The process of claim 11, wherein the dynamic report comprises at least one of:
a dynamic activity report;
a dynamic cohort report;
a dynamic settlement positional report;
a dynamic frequency report; and
a dynamic profile report.

17. The process of claim 11, further comprising reviewing and editing the WCC data of the WCC database using a WCC management tool installed in the user terminal.

18. The process of claim 17, wherein the WCC management tool displays a plurality of windows on a screen, the plurality of windows comprise at least one of:
a main window;
a settlement team window;
a plan of action window;
a claimant window;
a denied condition window;
a settlement attempt window;
a medical management window;
a litigation window; and
a lien window.

19. The process of claim 17, wherein the WCC management tool is configured to generate the dynamic report.

20. The process of claim 17, wherein the WCC management tool is configured to generate at least one of:
a pharmacy benefit management report;
an investigative report; and
a legal bill report.
